(19) United States
(12) Patent Application Publication
(10) Pub. No.: US 2011/0060482 A1
(43) Pub. Date: Mar. 10, 2011

(54) CONTROL ASSEMBLY

(75) Inventor: Mark Harrison, Melbourne (GB)

(73) Assignee: ROLLS-ROYCE PLC, LONDON (GB)

(21) Appl. No.: 12/851,120

(22) Filed: Aug. 5, 2010

(30) Foreign Application Priority Data
Sep. 7, 2009 (GB) 0915471.7

(51) Int. Cl. G06F 19/00

(52) U.S. Cl. 701/3

(57) ABSTRACT

A control assembly operable in the event of overheating of an engine electronic controller on an aircraft. The assembly including one or more temperature sensors located in the vicinity of the aircraft engine and connected to a control unit. The control unit is arranged to measure the temperature or temperatures detected by the sensors, and to determine whether in view of detected increased temperatures, a situation constitutes an emergency situation or a controlled situation. The control unit communicates a controlled situation to a pilot of the aircraft, and automatically causes an override action to occur to the aircraft engine when an emergency situation is determined.

This invention concerns a control assembly operable in the event of overheating of an engine electronic controller for an aircraft to prevent unsafe engine behaviour, an aircraft incorporating such an assembly, and also a method of controlling an aircraft in the event of overheating of the engine electronic controller of the aircraft.

It is potentially unsafe for an aircraft to operate when the engine electronic controller or controllers are at temperatures above the temperature specification of the respective electronics. Conventionally protection has been provided with temperature sensors to automatically shut down an engine when the temperature of the controller or controllers exceeds a specific value.

A problem with such a prior arrangement is that the arrangement could be activated and hence cause shutting down of one or more engines under adverse engine operating conditions if these conditions result in abnormally high temperatures local to the engine electronic controllers. This could occur in particular situations such as particularly high external temperatures which could be encountered when flying in a hot location, or if for instance volcanic ash was encountered. This could provide common conditions to one or more engines, which could result in the loss of more than one engine which could be potentially hazardous to the aircraft.

If however a rapid overheating of an engine electronic controller takes place, due for instance to a flammable fluid leak leading to a fire, or a burst hot air duct, then it is important for override action to take place quickly to avoid unsafe operation of the engine.

According to the present invention there is provided a control assembly operable in the event of overheating of an engine electronic controller on an aircraft, the assembly including one or more temperature sensors located in the vicinity of the aircraft engine and connected to a control unit, the control unit being arranged to measure the temperature or temperatures detected by the or one or more of the sensors, and to determine whether in view of detected increased temperatures, a situation constitutes an emergency situation or a controlled situation, to communicate a controlled situation to a pilot of the aircraft, and to automatically cause an override action to occur to the aircraft engine when an emergency situation is determined.

The override action may include closing down an engine of the aircraft. The override action may include disconnecting an engine control actuator output drive signal from the engine controller of the engine of the aircraft.

The control unit may be arranged to measure the rate of temperature increase detected by the or one or more of the sensors, and to determine whether in view of the rate of temperature increase detected a situation constitutes an emergency situation or a controlled situation.

The temperature sensors may be located at any of: on the aircraft engine; adjacent electronic controller for the engine; on the electronic controller for the engine; or within the electronic controller for the engine.

The control unit may be configured such that when the or one or more of the sensors detects a first predetermined temperature the control unit causes a first alarm signal to be given, and when a second predetermined higher temperature is detected the control unit causes a second alarm signal to be given.

The control unit may be configured to determine that an emergency situation has occurred when the temperature detected by the or one of the sensors has risen from a first predetermined temperature to a higher second predetermined temperature in a shorter period of time than a predetermined pilot reaction time.

The assembly may include a temperature sensor not located on the engine electronic controller, and which has a lower thermal lag than the engine electronic controller, with the control unit arranged such that when said sensor detects a temperature above a predetermined upper temperature limit the unit determines that a situation constitutes an emergency situation.

The assembly may be configured for a multi engine aircraft with one or more temperature sensors for the engine electronic controller on each engine. The assembly may be configured such that no more than one engine can be automatically closed down by an override action.

The invention also provides an aircraft incorporating an overheating control assembly according to any of the preceding eight paragraphs.

The invention still further provides a method of controlling an aircraft in the event of overheating of the or one or more of the engine electronic controllers of the aircraft, the method including measuring the temperature at one or more locations on the aircraft engine or engines, detecting when the temperature at the or one or more of the locations rises above a first predetermined temperature, detecting when the temperature rises above a second higher predetermined temperature, measuring the time taken between detection of the first and second temperatures, and if this time is less than a predetermined period, determining an emergency situation and causing an override action to occur.

An alarm may be provided to indicate when respectively each of the first and a second higher predetermined temperatures are detected.

The invention yet further provides a method of controlling an aircraft in the event of overheating of the or one or more of the engine electronic controllers of the aircraft, the method including measuring the temperature at one or more locations on the aircraft engine or engines spaced from the engine electronic controller and which have a lower thermal lag than the engine electronic controller, and if the temperature detected at said one or more locations rises above a predetermined upper temperature limit determining that a situation constitutes an emergency situation and automatically causing an override action to occur to the aircraft engine.

The override action may include closing down an engine of the aircraft. The override action may include disconnecting an engine control actuator output drive signal from the engine controller of the engine of the aircraft.

For a multi engine aircraft, temperatures are preferably measured for each engine, but where a first engine has been automatically closed down, upon an emergency situation being determined for a second engine, the second engine is not automatically closed down.

An embodiment of the present invention will now be described by way of example only and with reference to the accompanying drawings, in which:

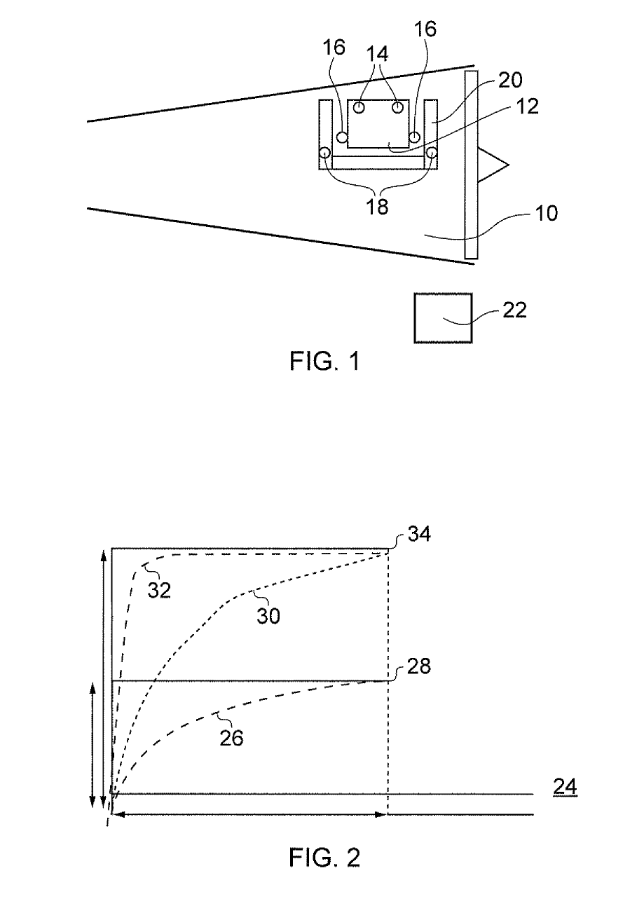

FIG. 1 is a diagrammatic view of an aircraft engine incorporating a control assembly according to the invention; and

FIG. 2 is a first graph illustrating operation of the assembly;

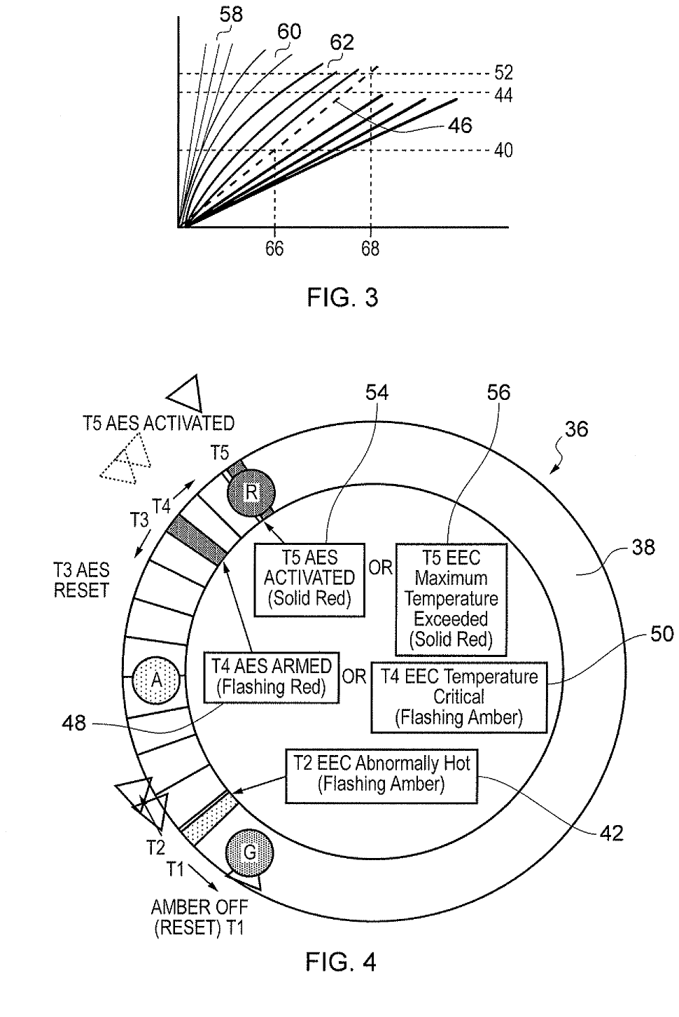

FIG. 3 is a second graph illustrating operation of the assembly; and

FIG. 4 is a diagrammatic cockpit display provided as part of the assembly of FIG. 1.

FIG. 1 shows an aircraft engine 10 with an engine electronic controller 12 mounted thereon. A first set of temperature sensors 14 are mounted within the controller 12. A second set of sensors 16 are provided on the outside of the controller 12. A third set of sensors 18 are mounted on a structure 20 on the engine 10 which has a lower thermal mass than the controller 12. The sensors 14, 16, 18 are connected to the engine electronic controller 12. In an alternative arrangement the sensors 14, 16, 18 could be connected to a separate unit 22.

FIG. 2 shows a graph of temperature (y axis) against time (x axis) for the three pairs of sensors 14, 16, 18 as recorded in the control unit 22. The line 24 illustrates an increased temperature detected by the sensors 14, 16, 18. When this temperature is detected an alert in the form of an amber caution will be provided to the crew of an aircraft powered by the engine 10.

The line 26 corresponds to the sensors 14 which have a relatively large thermal lag, and illustrate a temperature 28 being reached where the electronic controllers 12 are at their maximum temperature for safe working. The line 30 is a plot for the sensors 16 on the outside of the controller 12 which have a lower thermal lag.

The line 32 is a plot for the sensors 18 which have a significantly lower thermal lag. When the temperature indicated by the line 34 is reached this causes an automatic override action to occur. The override action could be for an engine 10 to be shut down, an output drive to be disconnected, and/or other steps to maintain the safety of the aircraft and potentially safe continuing use of the engine 10 if this is possible.

It can be seen from this graph that the high temperature increase for the lower lag sensors 18 can provide for an early override action when a rapid overheat occurs.

FIG. 3 shows a further graph of temperature (y axis) against time (x axis) in respect of a temperature sensor being used in an assembly according to the invention.

FIG. 4 shows a cockpit display 36 usable with the assembly, which will be described in conjunction with the graph shown in FIG. 3. The display 36 includes a temperature reading which moves in a clockwise direction from substantially lower bottom of a circular ring 38.

A first predetermined warning temperature T2 as shown by line 40 in FIG. 3 is set, and when this is reached a flashing amber light 42 will be lit on the display 36. The light 42 will continue to be lit unless the temperature falls below a lower temperature T1 which is spaced below T2 to provide some hysteresis.

A further predetermined increased temperature level T4 is set as by the line 44 in FIG. 3. The time taken for the temperature to increase between T2 and T4 is measured, and if this is quicker than an agreed pilot reaction rate as illustrated by the line 46 in FIG. 3 then the assembly will be “armed” which will cause light 48 on the display 36 to be lit and to flash. The light 48 is red.

If the rate shown by the line 46 is not met then a further light 50 will be lit as an alternative and will flash amber. If the temperature in fact decreases as far as T3 as shown on the display 36, then the respective light 48 or 50 will be extinguished. T3 is spaced below T4 to again provide some hysteresis.

If however the temperature continues to rise and reaches a higher predetermined level T5 as shown by the line 52 in FIG. 3, then if the light 48 has been lit due to a high rate of temperature increase the assembly will shut the respective engine down or cause another appropriate override action, and a further light 54 which is solid red will be lit. If the rate of temperature increase had been left under predetermined level and thus the light 50 had been lit, upon temperature T5 being reached a further solid red light 56 will be lit to indicate that maximum temperature had been exceeded.

Particular messages may be provided on or in connection with the lights on the display 36 as follows:
Light 42—Electronic Engine Control (EEC) abnormally hot
Light 48—Automatic Engine Shutdown (AES) armed
Light 50—EEC temperature critical
Light 54—AES activated
Light 56—EEC maximum temperature exceeded

The lights 54, 56 should preferably be latched in the aircraft in case the electronic engine control unit ceases to send such a message due to overheating.

FIG. 3 shows three extreme examples 58 caused for instance by a fire where the temperature has risen at a rate significantly higher than that illustrated by the line 46, and thus an override action has automatically taken place. Two less severe reactions caused for instance by a burst duct are shown at 60. Again though the rate of temperature increase is greater than the line 46 and therefore an automatic override action occurs. Two further scenarios now with leaking ducts are shown by the lines 62. Again the rate is greater than that shown by the line 46 and therefore an automatic override action takes place.

Four further scenarios 64 which could be caused by less severe leaking ducts, or for instance by blocked ventilation of the zone which locates the engine electronic controller, are shown, where the rate is less than the rate shown by the line 46. These are considered to be controlled situations and it is left to the crew to take appropriate action. The rate 46 is determined by an agreed crew reaction time as shown between the dotted lines 66 and 68 which is the time taken between the temperature reaching T2 the first level 40 and the third level T5 52. The crew reaction time could typically be five minutes.

The control unit 22 may be configured such that if the one engine 10 has been closed down, another engine on the aircraft is prevented from automatically closing down even if for instance the rate of temperature increase detected by one or more temperature sensors is greater than the rate 46. Assemblies according to the invention could be used in a wide range of different aircraft and with differing numbers of engines, and can be configured accordingly.

In some instances, and especially with single engine aircraft, the override action may be other than closing down of an engine. The override action could for instance constitute disconnecting an output drive. The override action could also or alternatively be to limit or restrict the engine to a predetermined level of one or more features such as for instance the fuel supply, the compressor vane geometry, or the propeller pitch.

There is thus described a control assembly operable in the event of overheating of an engine electronic controller, an aircraft fitted with such an assembly, and also a method of controlling an aircraft in the event of overheating of the engine electronic controller, which provide for a number of advantages relative to prior proposals. Providing for an automatic override action only in emergency situations ensures that if the engine electronic controller rapidly moves to an unsafe working temperature the engine will be closed down. If however there is a controlled situation with a more gradual temperature increase the situation is left in the control of the pilot, which is generally the preferred situation, who can take appropriate remedial action.

With multi engine aircraft the provision of an interlock to prevent, for instance, shut down of more than one engine, obviously provides for enhanced safety. This could be particularly applicable in scenarios where conditions are encountered which are common to more than one engine, such as moving into a hot area or a scenario such as volcanic dust, where otherwise a simultaneous multiple engine shutdown could occur which may be catastrophic.

A wide range of other modifications may be made without departing from the scope of the invention. For instance a different number or location of temperature sensors could be provided. The temperature, rate of temperature rise which determines an emergency situation, and also the crew reaction time can be chosen as appropriate for particular situations and aircraft.

1. An aircraft incorporating a control assembly operable in the event of overheating of an engine electronic controller on an aircraft, the assembly including one or more temperature sensors located in the vicinity of the aircraft engine controller to measure the temperature of the controller and connected to a control unit, the control unit being arranged to measure the temperature or temperatures detected by the one or more of the sensors, and to determine whether in view of detected increased temperatures of the controller, a situation constitutes an emergency situation or a controlled situation, to communicate a controlled situation to a pilot of the aircraft, and to automatically cause an override action to occur to the aircraft engine when an emergency situation is determined.

2. An assembly according to claim 1, wherein, the override action includes closing down an engine of the aircraft.

3. An assembly according to claim 1, wherein, the override action includes disconnecting an engine control actuator output drive signal from the engine controller of the engine of the aircraft.

4. An assembly according to claim 1, wherein, the control unit is arranged to measure the rate of temperature increase detected by the or one or more of the sensors, and to determine whether in view of the rate of temperature increase detected a situation constitutes an emergency situation or a controlled situation.

5. An assembly according to claim 1, wherein, the one or more temperature sensors are located at any of: on the aircraft engine; adjacent electronic controller for the engine; on the electronic controller for the engine; or within the electronic controller for the engine.

6. An assembly according to claim 1, wherein, the control unit is configured such that when the or one or more of the sensors detects a first predetermined temperature the control unit causes a first alarm signal to be given, and when a second predetermined higher temperature is detected the control unit causes a second alarm signal.

7. An assembly according to claim 1, wherein, the control unit is configured to determine that an emergency situation has occurred when the temperature detected by the or one of the sensors has risen from a first predetermined temperature to a higher second predetermined temperature, in a shorter period of time than a predetermined pilot reaction time.

8. An assembly according to claim 1, wherein, assembly includes a temperature sensor not located on the engine electronic controller, and which has a lower thermal lag than the engine electronic controller, with the control unit arranged such that when said sensor detects a temperature above a predetermined upper temperature limit the unit determines that a situation constitutes an emergency situation.

9. An assembly according to claim 1, wherein, the assembly is configured for a multi engine aircraft with one or more temperature sensors for the engine electronic controller on each engine.

10. (canceled)

11. A method of controlling an aircraft in the event of overheating of the one or more engine electronic controllers of the aircraft, the method including measuring the temperature of the one or more controllers at one or more locations on the aircraft engine or engines, detecting when the temperature at the or one or more of the locations rises above a first predetermined temperature, detecting when the temperature rises above a second higher predetermined temperature, measuring the time taken between detection of the first and second temperatures; and if this time is less than a predetermined period, determining an emergency situation and causing an override action to occur; and if this time is more than a predetermined period, determining a controlled situation and communicating the controlled situation to the pilot.

12. A method according to claim 11, wherein, an alarm is provided to indicate when each of the first and a second higher predetermined temperatures are detected.

13. A method according to claim 11, comprising measuring the temperature at one or more locations on the aircraft engine or engines spaced from the engine electronic controller and which have a lower thermal lag than the engine electronic controller, and if the temperature detected at said one or more locations rises above a predetermined upper temperature limit determining that a situation constitutes an emergency situation and automatically causing an override action to occur to the aircraft engine.

14. A method according to claim 13, wherein, the override action includes disconnecting an engine control actuator output drive signal from the engine controller of the engine of the aircraft.

15. An assembly according to claim 2, wherein, the assembly is configured for a multi engine aircraft with one or more temperature sensors for the engine electronic controller on each engine.

16. An assembly according to claim 15, wherein the assembly is configured such that no more than one engine can be automatically closed down by an override action.
